(19) United States
(12) Patent Application Publication
(10) Pub. No.: US 2012/0057631 A1
(43) Pub. Date: Mar. 8, 2012

(54) Method and device for motion estimation of video data coded according to a scalable coding structure

(75) Inventor: Fabrice LE LEANNEC, Mouaze (FR)

(73) Assignee: CANON KABUSHIKI KAISHA, Tokyo (JP)

(21) Appl. No.: 13/193,386

(22) Filed: Jul. 28, 2011

(30) Foreign Application Priority Data
Sep. 3, 2010 (GB) 1014667.8

(51) Int. Cl. H04N 7/26

(52) U.S. Cl. 375/240.16; 375/240.24; 375/E07.124; 375/E07.026

(57) ABSTRACT

A technique for searching a reference picture including a plurality of reference blocks for a block that best matches a current block in a current picture. A subset of current blocks is designated in a current picture. A first search operation is applied to the subset of current blocks and a second search operation is applied to current blocks outside of the subset. A search area within a corresponding reference picture is of a variable size in the first operation, whereas the second operation is a basic four-step motion search.

### BACKGROUND OF THE INVENTION

1. Field of the Invention

Embodiments of the present invention relate to video data compression. In particular, one disclosed aspect of the embodiments relates to H.264 encoding and compression, including scalable video coding (SVC) and motion compensation.

2. Description of the Related Art

H.264/AVC (Advanced Video Coding) is a standard for video compression that provides good video quality at a relatively low bit rate. It is a block-oriented compression standard using motion-compensation algorithms. By block-oriented, what is meant is that the compression is carried out on video data that has effectively been divided into blocks, where a plurality of blocks usually makes up a video picture (also known as a video frame). Processing pictures block-by-block is generally more efficient than processing pictures pixel-by-pixel and block size may be changed depending on the precision of the processing. The compression method uses algorithms to describe video data in terms of a movement or translation of video data from a reference picture to a current picture (i.e., for motion compensation within the video data). This is described in more detail below.

In order to process video pictures, each of the pictures in the video data is divided into a grid, each square in the grid having an area referred to as a macroblock. The macroblocks are made up of a plurality of pixels and have a defined size. A current macroblock with the defined size in the current picture is compared with a reference area with the same defined size in the reference picture. However, as the reference area is not necessarily aligned with one of the grid squares, and may overlap more than one grid square, this area is not generally known as a macroblock. Rather, the reference area, because it is (macro) block-sized, will hereinbelow be referred to as a reference block to differentiate from a macroblock that is aligned with the grid. In other words, a current macroblock in the current picture is compared with a reference block in the reference picture. For simplicity, the current macroblock will also be referred to as a current block.

A motion vector between the current block and the reference block is computed in order to perform a temporal prediction of the current block. Defining a current block by way of a motion vector (i.e., of temporal prediction) from a reference block will, in many cases, use less data than intra-coding the current block completely without the use of a reference block. Indeed, for each macroblock in each picture, it is determined whether Intra-coding (involving spatial prediction) or Inter-coding (involving temporal prediction) will use less data (i.e., will “cost” less) and the appropriate coding technique is respectively performed. This enables better compression of the video data. Specifically, for each block in a current picture, an algorithm is applied which determines the “cost” of Intra-coding the block and the “cost” of the best available Inter-coding mode. The “cost” can be determined as a known rate distortion cost (reflecting the compression efficiency of the evaluated coding mode) or as a simpler, also known, distortion metric (e.g., the sum of absolute differences between original block and its prediction). This rate distortion cost may also be considered to be a compression factor cost.

An extension of H.264/AVC is SVC (Scalable Video Coding) which encodes a video bitstream by dividing it into a plurality of scalability layers containing subset bitstreams. Each subset bitstream is derived from the main video bitstream by filtering out parts of the main bitstream to give rise to subset bitstreams of lower spatial or temporal resolution or lower quality video than the full video bitstream. Some subset bitstreams corresponding to the lowest spatial and quality layer can be read directly and can be decoded with an H.264/AVC decoder. The remaining subset bitstreams may require a specific SVC decoder. In this way, if bandwidth becomes limited, individual subset bitstreams can be discarded, merely causing a less noticeable degradation of quality rather than complete loss of picture.

Functionally, the compressed video comprises a base layer that contain basic video information, and enhancement layers that provide additional quality, spatial or temporal refinement. It is these enhancement layers that may be discarded in the finding of a balance between high compression (giving rise to low file size) and high quality video data.

The algorithms that are used for compressing the video data stream deal with relative motion of images between video frames that are called picture types or frame types. The three main picture types are I, P and B pictures.

An I-picture (or frame) is an “Intra-coded picture” and is self-contained. I-pictures are the least compressed of the frame types but do not require other pictures in order to be decoded and produce a full reconstructed picture.

A P-picture is a “predicted picture” and holds motion vectors and residual data computed between the current picture and a previous picture (the latter used as the reference picture). P-pictures can use data from previous pictures to be decompressed and are more compressed than I-pictures for this reason.

A B-picture is a “Bi-predictive picture” and holds motion vectors and residual data computed between the current picture and both a preceding and a succeeding picture (as reference pictures) to specify its content. As B-pictures can use both preceding and succeeding pictures for data reference to be compressed, B-pictures are potentially the most compressed of the picture types. P- and B-pictures are collectively referred to as “Inter” pictures or frames.

Pictures may be divided into slices. A slice is a spatially distinct region of a picture that is encoded separately from other regions of the same picture. Furthermore, pictures can be segmented into macroblocks. A macroblock is a type of block referred to above and may comprise, for example, a square array of 16×16 pixels. I-pictures contain only I-macroblocks. P-pictures may contain either I-macroblocks or P-macroblocks and B-pictures may contain any of I-, P- or B-macroblocks. Sequences of macroblocks may make up slices so that a slice is a predetermined group of macroblocks.

Pictures or frames may be individually divided into the base and enhancement layers described above.

If each picture in a video stream were to be Intra-encoded, a huge amount of bandwidth would be required to carry the encoded video stream. In order to reduce the amount of space used by the encoded stream, a characteristic of the video stream is used which is that sequential pictures (as there are, say, 24 pictures per second in a typical video stream) will generally have only minor differences between them. This is because only a small amount of movement will have taken place in the video image in a 24^{th} of a second. The pictures may therefore be compared with each other and only the differences between them are represented (by motion vectors and residual data) and encoded. This is known as motion-compensated temporal prediction.

Inter-macroblocks (i.e. P- and B-macroblocks) correspond to a specific set of macroblocks that undergo motion-compensated temporal prediction. In this temporal prediction, a motion estimation step is performed by the encoder. This step computes the motion vectors used to optimize the prediction of the macroblock. In particular, a further partitioning step, which divides macroblocks in P- and B-pictures into rectangular partitions with different sizes, is also performed in order to optimize the prediction of the data in each macroblock. These rectangular partitions each undergo a motion compensated temporal prediction. For example, the partitioning of a 16×16 pixel macroblock into blocks is determined so as to find the best rate distortion trade-off to encode the respective macroblock.

Motion estimation is performed as follows. An area of the reference picture is searched to find the best matching reference block of the current block according to the employed rate distortion metric. The area that is searched will be referred to as the search area. If no suitable temporal reference block is found, the cost of the Inter-prediction is determined to be high when it is compared with the cost of Intra-prediction. The coding mode with the lowest rate-distortion cost is chosen. The block in question is thus likely to be Intra-coded.

When allocating the search area, a co-located reference block is compared with the current block. The co-located reference block is the reference block that is in the same (spatial) position within the reference picture as the current block is within its own picture. The search area is then a predefined area around this co-located reference block. If a sufficiently matching reference block is not found, the cost of the Inter-prediction is determined as being too great and the current block is likely to be Intra-coded.

A temporal distance (or “dimension” or “domain”) is one that is a picture-to-picture distance, whereas a spatial distance is one that is within a picture.

H.264/AVC Video data streams are made of groups of pictures (GOP) which contain, for example, one or more I-pictures and all of the B-pictures and/or P-pictures for which the I-picture is a reference. More specifically in the case of SVC, a GOP consists of a series of B-pictures between two I- or P-pictures. The B-pictures within this GOP employ the book-end I- or P-pictures for temporal prediction. Thus, the reference pictures for currently-encoded pictures will be within the same GOP. However, when a GOP is long (with a large number of pictures), the reference picture may be far away from the current picture; this “temporal distance” may be, for example, 16 pictures. In a sequence of pictures that displays high-speed motion, the movement of an image detail that is in a reference block in the reference picture may have moved significantly within the picture (in the “spatial distance”) over those 16 pictures. This means that, during motion estimation, when searching in the search area for a reference block that most closely matches the current block, a larger area within the reference picture must be searched. This is because the most closely matching reference block is more likely to be further away from the co-located reference block in a more dynamic video sequence than in a less dynamic video sequence or than in shorter GOPs. Large search areas give rise to slower searches, which slows the computing of the best Inter-prediction mode. Therefore, a trade-off has to be found between a large motion search area, leading to better temporal predictors, and the speed of the encoding process.

U.S. Pat. No. 5,731,850 (Maturi et al.) describes a motion compensation process for use with B-pictures whereby the search area in a reference picture is changed in accordance with the change in temporal distance between the B-picture and its reference picture. This is an improvement on the previously-known full-search block-matching motion estimation method, which checks whether each pixel of a current picture matches the co-located pixel of a reference picture, and if not, all other pixels of the reference picture are searched until a best-matching one is found.

However, the search method of U.S. Pat. No. 5,731,850 is still a coarse method that simply increases the initial search area in the reference picture when the temporal distance between the current picture and the reference picture is above a certain threshold.

### BRIEF SUMMARY OF THE INVENTION

It is desirable to improve the motion estimation process in video compression while maintaining a high coding speed.

According to a first aspect of one embodiment, there is provided a technique of searching a reference picture including a plurality of reference blocks for reference blocks that best match current blocks in a current picture. The technique includes: designating a subset of current blocks in the current picture; applying a first operation to the current blocks within the subset of current blocks to search for reference blocks in a first search area in the reference picture that best match said current blocks within the subset; and applying a second operation to the current blocks not within the subset of current blocks to search for reference blocks in a second search area in the reference picture that best match said current blocks not within the subset.

In other words, the first operation applies a first motion estimation process to the subset of current blocks and the second operation applies a second motion estimation process to the rest of the current blocks. The second motion estimation process is preferably a basic motion estimation process that uses a small search area and determines relatively quickly whether an appropriate reference block will be found in that area. The first motion estimation process preferably uses an extended search area, in which an appropriate reference block may be more likely to be found (at least in certain circumstances), but the search process and therefore the encoding process may take longer.

The advantage of this technique is that a balance may be found between maintaining a fast motion estimation process with the second operation, and an increased compression rate by interspersing the second, faster operation with the first, more detailed but potentially slower operation for selected current blocks.

According to a second aspect of one embodiment, there is provided a technique for encoding a video sequence including at least one group of pictures, the pictures each including a plurality of blocks. The technique includes, for each current block within each current picture in the video sequence, obtaining a first rate distortion cost associated with a first encoding mode using the reference block found for said current block by the searching technique; obtaining a second rate distortion cost associated with a second encoding mode for encoding said current block; comparing said obtained first and second rate distortion costs; and encoding said current block according to the best encoding mode according to said comparison.

According to a third aspect of one embodiment, there is provided a video encoding apparatus for encoding a video sequence including at least one group of pictures, the pictures each including a plurality of blocks. The video encoding apparatus includes: means for selecting a current picture in the group of pictures; means for designating a subset of current blocks in the current picture; means for selecting a reference picture in which to search for a reference block that best matches each current block in the current picture; means for applying a first operation or process to the current blocks within the subset of current blocks to search for reference blocks in a first search area in the reference picture that best match said current blocks within the subset; and means for applying a second operation or process to the current blocks not within the subset of current blocks to search for reference blocks in a second search area in the reference picture that best match said current blocks not within the subset.

The embodiments may improve the trade-off between encoding speed and compression efficiency (i.e., rate distortion performance).

### BRIEF DESCRIPTION OF THE DRAWINGS

The embodiments will herein below be described, purely by way of example, and with reference to the attached figures, in which:

FIG. 1 depicts the architecture of an encoder usable according to one embodiment;

FIG. 2 is a schematic diagram of the encoding process of an H.264 video bitstream;

FIG. 3 is a schematic diagram of the encoding process of individual layers of an SVC bitstream;

FIG. 4 is a flow chart showing the determination of best compression mode;

FIG. 5 depicts the temporal layers of pictures in a group of pictures;

FIG. 6A depicts a predicted motion vector and a co-located block;

FIG. 6B depicts a search area around a block according to a four-step search operation;

FIG. 7 depicts a predicted motion vector and a search area around a co-located block according to an extended search operation; and

FIG. 8 depicts a group of pictures processed according to a second embodiment.

### DETAILED DESCRIPTION OF THE INVENTION

The specific embodiment below will describe the encoding process of a video bitstream using scalable video coding (SVC) techniques. However, the same process may be applied to an H.264/AVC system. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

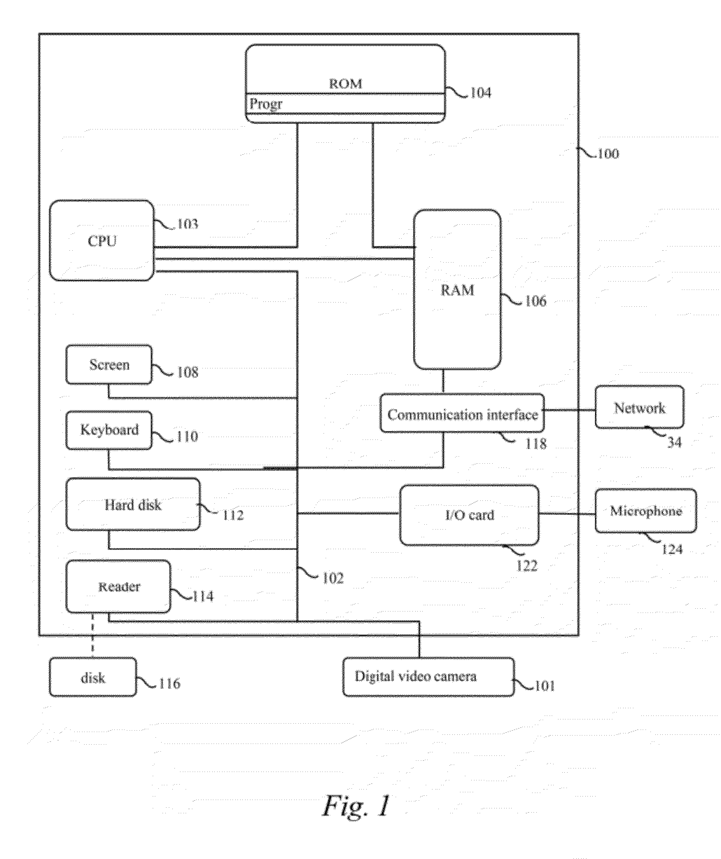

FIG. 1 illustrates an encoder 100 attached to a network 34 for communicating with other devices on the network. The encoder 100 may take the form of a computer, a mobile (cell) telephone, or similar. The encoder 100 uses a communication interface 118 to communicate with the other devices on the network (other computers, mobile telephones, etc.). The encoder 100 also has optionally attachable or attached to it a microphone 124, a disk 116 and a digital video camera 101, via which it receives data processed (in the disk 116 or digital video camera 101) or to be processed by the encoder. The encoder itself contains interfaces with each of the attachable devices mentioned above; namely, an input/output card 122 for receiving audio data from the microphone 124 and a reader 114 for reading the data from the disk 116 and the digital video camera 101. The encoder 100 will also have incorporated in, or attached to, it a keyboard 110 or any other means such as a pointing device, for example, a mouse, a touch screen or remote control device, for a user to input information; and a screen 108 for displaying video data to a user and/or for acting as a graphical user interface. A hard disk 112 will store video data that is processed or to be processed by the encoder 100. Two other storage systems are also incorporated into the encoder, the random access memory (RAM) 106 or cache memory for storing registers for recording variables and parameters created and modified during the execution of a program that may be stored in a read-only memory (ROM) 104. The ROM is generally for storing information required by the encoder for encoding the video data, including software (i.e., a computer program) for controlling the encoder. A bus 102 connects the various devices in the encoder 100 and a central processing unit (CPU) 103 controls the various devices.

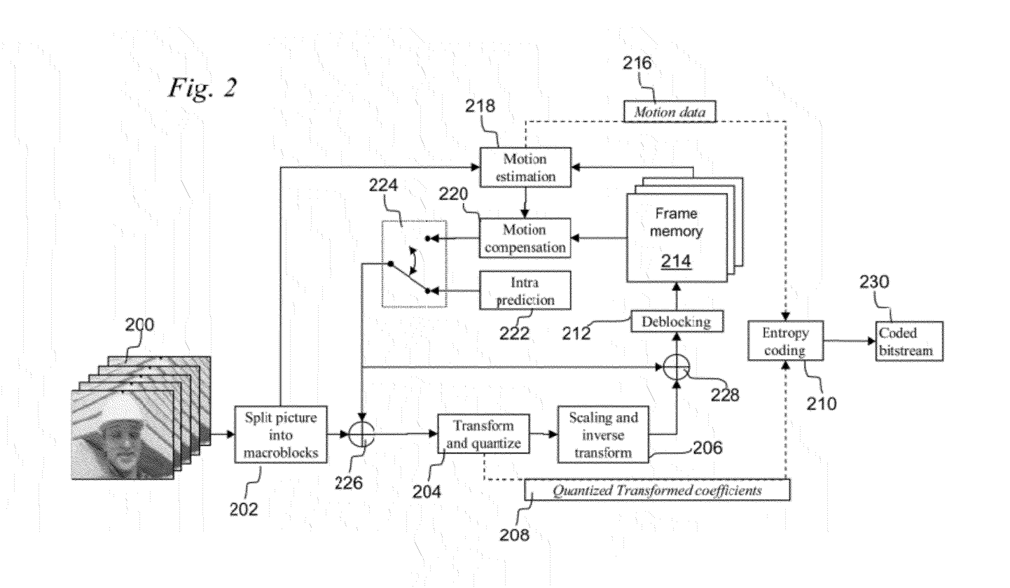

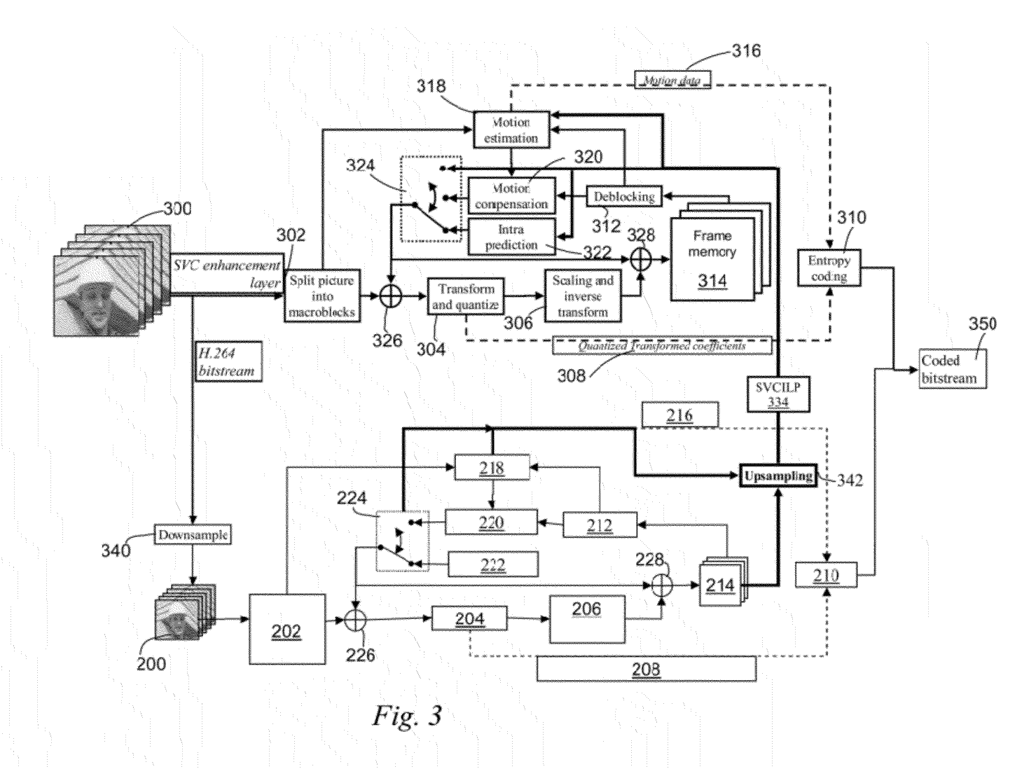

FIG. 2 is a conceptual diagram of an H.264/AVC encoder applying the H.264/AVC coding process to video data 200 to create coded AVC bitstream 230. FIG. 3, on the other hand, is a conceptual diagram of an H.264/SVC encoder applying an H.264/SVC coding process to an input video sequence 300 to create SVC bitstream 350. The input video sequence 300 is made, in the present case, of two scalability layers including a base layer that is the same as the input video sequence 200 of FIG. 2. The same reference numerals are used in FIGS. 2 and 3 where the same processes are performed. The second of the two scalability layers is an enhancement layer.

The input to the non-scalable H.264/AVC encoder of FIG. 2 consists of an original video sequence 200 that is to be compressed. The encoder successively performs the following steps to encode the H.264/AVC compliant bitstream. A current picture (i.e., one that is to be compressed next) is divided 202 into 16×16 macroblocks also called blocks in the following for simplicity. Each block first undergoes a motion estimation operation 218, in which an attempt is made to find, amongst reference pictures stored in a dedicated memory buffer, at least one reference block that will provide a good prediction of the image portion contained in the current block. This motion estimation operation 218 generally provides identification of one or two reference pictures that contain any found reference blocks, as well as the corresponding estimated motion vectors, which are connectors between the current block and the reference blocks and will be defined below.

A motion compensation operation 220 then applies the estimated motion vectors to the found reference blocks and copies the thus-obtained blocks into a temporally predicted picture. A temporally predicted picture is one that is made up of identified reference blocks, these reference blocks having been displaced from a co-located position by distances determined during motion estimation and defined by the motion vectors. In other words, a temporally predicted picture is a representation of the current picture that has been reconstructed using motion vectors and the reference picture(s). In the special case of bi-predicted blocks, where two reference pictures are available for the prediction of a current block in a current picture, the predicted block that is incorporated in the predicted picture is an average (e.g., a weighted average) of the two reference blocks found in the two reference pictures.

The best rate distortion cost obtained by the inter prediction is then stored as “Best Inter Cost” for comparison with the rate distortion cost of Intra-coding.

Meanwhile, an Intra prediction operation 222 determines an Intra-prediction mode that may provide the best performance in predicting the current block and encoding it in Intra mode. By Intra mode, what is meant is that intra-spatial prediction (prediction using data from the current picture itself) is employed to predict the currently-considered block and no temporal prediction is used. “Spatial” prediction and “temporal” prediction are alternative terms that reflect the characteristics of “Intra” and “Inter” prediction respectively. Specifically, as Intra prediction predicts pixels in a block using neighboring information from the same picture. The result of Intra prediction is a prediction direction and a residual.

From the Intra prediction operation 222, a “Best Intra Cost” is obtained.

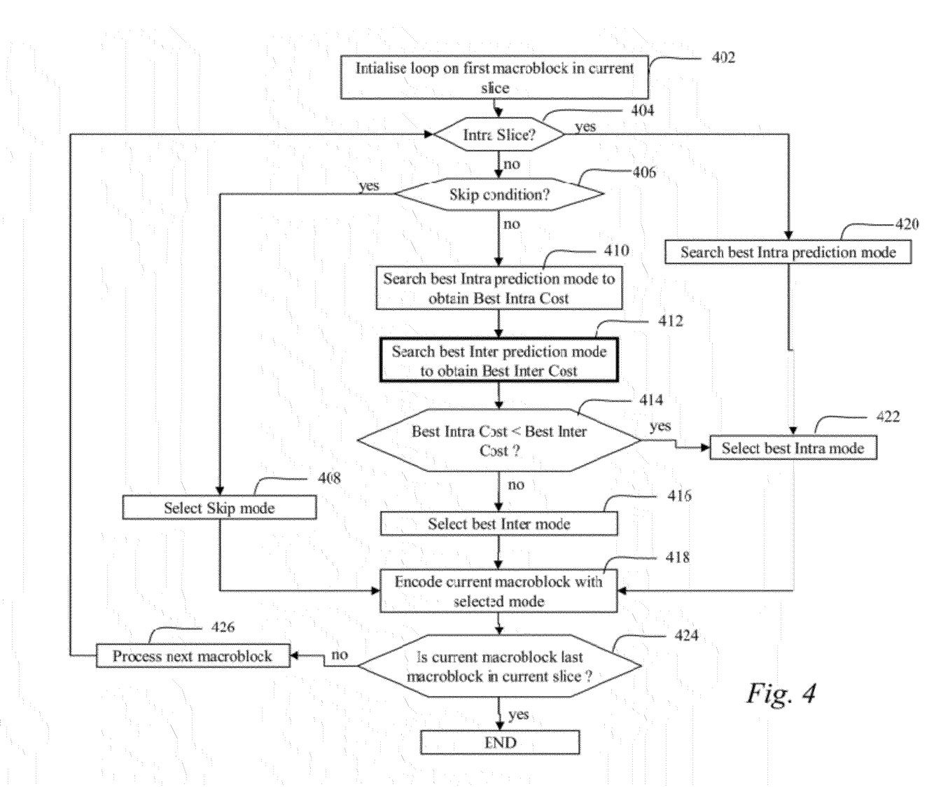

Next, a coding mode selection mechanism 224 chooses the coding mode, among the spatial and temporal predictions, that provides the best rate-distortion trade-off in the coding of the current block. The way this is done is described later with reference to FIG. 4 but the Best Inter cost and the Best Intra Cost are effectively compared and the lower cost is selected. The result of this operation is a “predicted block” determined by the lower cost coding mode. The difference between the current block (in its original version) and the predicted block is calculated 226, which provides the residual to compress. The residual block then undergoes a transform (Discrete Cosine Transform or DCT) and a quantization 204.

The current block is reconstructed through an inverse quantization, an inverse transform 206, and a sum 228 of the inverse transformed residual (from 206) and the prediction block (from 224) of the current block. Once the current picture is reconstructed 212, it is stored in a memory buffer 214 so that it may be used as a reference picture to predict subsequent pictures to encode.

An entropy encoding operation 210 has, as an input, the coding mode (from 224) and, in case of an Inter block, the motion data 216, as well as the quantized DCT coefficients 208 previously calculated. This entropy encoder 210 encodes each of these data into their binary form and encapsulates the thus-encoded block into a container called a NAL unit (Network Abstract Layer unit). A NAL unit contains all encoded blocks from a given slice. A slice is a contiguous set of macroblocks inside a same picture. A picture contains one or more slices. An encoded H.264/AVC bitstream thus consists of a series of NAL units.

As mentioned above, the SVC encoding process of FIG. 3 comprises two stages, each of which handles items of data of the bitstream according to the layer to which they belong. The first, lower stage is the coding of the base layer as described above. The second stage is the coding of the SVC enhancement layer on top of the base layer. This enhancement layer brings a refinement of the spatial resolution to the base layer.

In order to generate two coded scalability layers, a downsampling operation 340 is performed on each input original picture to provide the lower, AVC encoding stage that represents an original picture with a reduced spatial resolution. Then, given this downsampled original picture, the processing of the base layer is the same as in FIG. 2 and is numbered in the same way. A non-downsampled, full resolution, original picture is provided to the SVC enhancement layer coding stage of FIG. 3.

As shown by FIG. 3, the coding scheme of this enhancement layer is similar to that of the base layer, except that for each block of a current picture being compressed, an additional prediction mode can be chosen by the coding mode selection module 324. This new coding mode (the top-most terminal in switch 324) corresponds to the inter-layer prediction of SVC, implemented by the SVC inter-layer prediction (SVCILP) module 334. Inter-layer prediction 334 consists of re-using the data coded in a layer lower than current refinement layer as prediction data of the current block. The lower layer used is called the reference layer for the inter-layer prediction of the current enhancement layer. In a case wherein the reference layer contains a picture that temporally coincides with the current picture, then it is called the base picture of the current picture. The co-located block (i.e., the block at same spatial position) of the current block that has been coded in the reference layer may be used as a reference to predict the current block in the enhancement layer. More precisely, the prediction data that may be used in the co-located block corresponds to: the coding mode, a block partition, the motion data (if present) and the texture data (spatial/temporal residual or reconstructed Intra block). The block partition may be a sub-area of a block that is less than the 16×16-pixel size of the block and may be, for instance, half of a block—16×8 or 8×16 pixels; half of a half of a block—8×8 pixels; half of a half of a half of a block—8×4 or 4×8 pixels; or even a 4×4 pixel partition or less. In case of coding a spatial enhancement layer, some up-sampling operations of the texture and motion prediction data are performed.

Referring specifically to FIG. 3, as for the base layer, the enhancement layer is divided 302 into blocks. Each block undergoes a determination operation to determine which of temporal prediction and Intra prediction may be most “cost” effective for that block. In other words, the coding mode selection mechanism 324 chooses the coding mode, among the spatial 322, temporal 318, 320 and inter-layer 334 predictions, that provides the best rate-distortion trade-off in the coding of the current block. The blocks for which temporal prediction is found to be most cost effective (such that the switch of the coding method selector 324 is at the middle input) first undergo a motion estimation operation 318, in which the attempt is made to find at least one reference block for the prediction of the image portion contained in the current block. Inter-layer prediction information may also be used in the motion estimation operation 318. A motion compensation operation 320 then applies the estimated motion vectors to the found reference blocks and copies the thus-obtained blocks into a temporally predicted picture.

On the other hand, for blocks for which Intra prediction gives the best rate distortion cost, Intra prediction operation 322 determines a spatial prediction mode that may provide the best performance in predicting the current block. The difference between the current block (in its original version) and the prediction block is calculated 326, which provides the (temporal or spatial) residual to compress. The residual block then undergoes a transform (DCT) and a quantization 304. The current block is reconstructed through an inverse quantization, an inverse transform 306, and a sum 328 of the inverse transformed residual (from 306) and the prediction block (from 324) of the current block. Once the current picture is reconstructed 312, it is stored in a memory buffer 314 so that it may be used as a reference picture to predict subsequent pictures to encode. Finally, as for the base layer, a last entropy coding operation 310 receives the motion data 316 and the quantized DCT coefficients 308 previously calculated. This entropy coder 310 encodes the data in their binary form and encapsulates them into a NAL unit, which is output as a coded bitstream 350.

As a first operation in encoding video data, the data is loaded (or received) into the encoder (e.g. from the disk 116 or camera 101) as groups of pictures. Once received, the pictures may then be encoded.

FIG. 4 illustrates an initial coding mode selection operation or process that is used to select (324) the coding mode for each block. By “coding mode”, what is meant is either the Intra 322 or Inter 320 coding or the SVCILP module 334 as described above. The input data into the operation or the process (from the video data 300 and frame memory 314) are: a current block that is to be encoded next; reconstructed neighboring Intra blocks (to provide spatial prediction information); neighboring Inter blocks (to provide useful information to predict the motion vector for the current block); and at least one reference picture for temporally predicting the current picture containing the current block.

The output of the operation or process is a coding mode for the current block that is most efficient, taking into account the other input data.

The operation or process begins with the input of the first block of the first slice of the image data in operation 402. Then, the current block is tested 404 to determine whether it is contained in an Intra slice (an I-slice). If the current block is contained in an Intra slice and is thus an I-block (yes in operation 404), a search 420 is performed to find the best Intra coding mode for the current block. If the current block is not an I-block (no in operation 404), the operation or process proceeds to the next step, operation 406.

In operation 406, the operation or process derives a reference block of the current block according to a SKIP mode. This derivation method uses a direct mode prediction process, as specified in the H.264/AVC standard. Residual texture data that is output by the direct mode is calculated by subtracting the found reference block from the current block. This residual texture data is transformed and quantized and if the quantization output gives rise to all zero coefficients (yes in operation 406), then the SKIP mode is adopted 408 as the best mode for the current block and the operation or process ends inasfar as that block is concerned. On the other hand, if the SKIP mode requirements are not satisfied (no in operation 406), then the encoder moves on to operation 410.

Operation 410 is a search of Intra coding modes to determine the best Intra coding mode for the current block. In particular, this is the determination of the best spatial prediction and best partitioning of the current block in the Intra mode. This gives rise to the Intra mode that has the lowest “cost” and is known as the Best Intra Cost. It takes the form of a SAD (sum of absolute differences) or a SATD (sum of absolute transform differences).

Next, the operation or process determines the best Inter coding mode for the current block in operation 412. It is this operation that is the subject of one embodiment. This includes a forward estimation process in the case of a P-slice containing the current block, or forward estimation process followed by a backward estimation process followed by a bi-directional motion operation in the case of a B slice containing the current block. For each temporal direction (forward and backward), a block partition that gives rise to the best temporal predictor is also determined. The temporal prediction mode that gives the minimum SAD or SATD is selected as the best Inter coding mode and the cost associated with it is the Best Inter Cost.

In operation 414, the Best Intra Cost is compared with the Best Inter Cost. If the Best Intra Cost is found to be lower (yes in operation 414) than the Best Inter Cost, the best Intra mode is selected 422 as the mode to be applied to the current block. On the other hand, if the Best Inter Cost is found to be lower (no in operation 414), the Best Inter Mode is selected 416 as the encoding mode to the applied to the current block.

In operation 418 of the operation or process, the SKIP, Inter or Intra mode is applied as the encoding mode of the current block as selected in operations 408, 416 or 422 respectively.

In operation 424, it is determined whether the current block is the last block in current slice. If so (yes in operation 424), the slice is encoded and the operation or process ends. If not (no in operation 424), the next block is input 426 as the next current block.

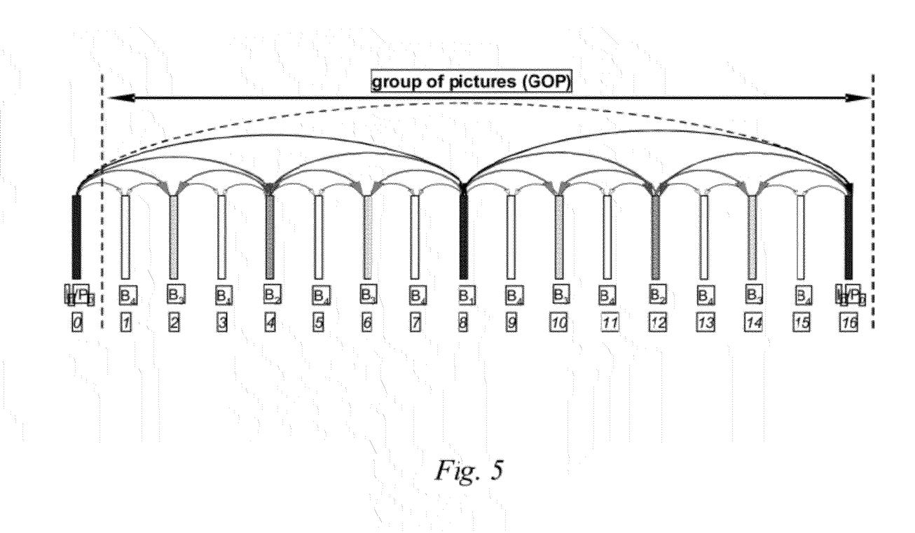

If the blocks satisfy operation 404 or 406, the decision of which prediction mode to use is relatively short. Specifically, if the blocks are in a slice of a picture that is in a specific position in a video sequence, those blocks are easily determined as satisfying the requirements for the Intra-coding or the SKIP coding. This positioning of the pictures in the video sequence will be discussed further below with reference to FIG. 5.

If the blocks do not satisfy operation 404 or 406, the decision process takes longer, as a motion search has to be performed for suitable reference blocks in the reference pictures in order to determine the Best Inter Mode (and Best Inter Cost). One embodiment is concerned with improving this search process.

A video data sequence may include at least one group of pictures (GOP) that comprises a key or anchor picture such as an I-picture or P-picture (depending on whether it is coded independently as an Intra-picture (I-picture) or based on the I- or P-picture of the previous GOP (P-picture)) and a plurality of B-pictures. The B-pictures may be predicted during the coding process using other already—encoded pictures before and after it.

The pictures or frames of the video data sequence are loaded from their source (e.g., a camera 101, etc.) in the order shown in FIG. 5, from 0 to 16. In other words, the pictures are loaded chronologically or “temporally”. The GOP shown in FIG. 5 has an I-/P-picture as the zeroth picture because, even though it forms part of a previous GOP, it is used for prediction of pictures in the present GOP and its position relative to the current GOP is thus relevant.

Despite the pictures being loaded temporally, they may not be encoded in this order. Rather, they may be encoded in the following order: I₀/P₀; B₁; (two times) B₂; (four times) B₃; and then (eight times) B₄. The reason for this coding order is that I₀/P₀ of the current GOP uses information from the I₀/P₀ of the previous GOP to be coded first. This is illustrated by a dotted arrow linking the two I₀/P₀ pictures. Next, B₁ uses information from both I₀/P₀ pictures from the previous GOP and the current GOP to be encoded. This provides a temporal scalability capability. The relationship between B₁ and the I₀/P₀ pictures is shown by two darkly-shaded arrows. Next are encoded B₂ pictures, of which there are two, halfway between each I₀/P₀ picture and the B₁ picture respectively. In the four temporal “spaces” between each I₀/P₀, B₁ and B₂ picture, four B₃ pictures are encoded respectively. Finally, in the remaining spaces, eight occurrences of B₄ pictures are encoded.

The pictures are thus encoded in an order depending on the order in which their respective reference pictures are available (i.e., the respective reference pictures are available when they have been encoded themselves).

The name “temporal level” or “temporal layer” is given to the index applied to the pictures shown in FIG. 5. The temporal level of the I₀/P₀ pictures is thus 0. The temporal level of the B₁ picture is thus 1, and so on.

The temporal level of pictures is linked to a hierarchy of encoding (and decoding) that is performed to those pictures. The first pictures to be encoded have lower temporal levels. The temporal level of a picture is not to be confused with temporal distance between pictures, which is the length of time between the loadings of pictures.

If the available bandwidth is such that the entire GOP cannot be encoded/transmitted, the pictures that are highest in temporal level may be the first to be discarded. In other words, the eight B₄ pictures may be discarded first should the need for a smaller amount of data arise. This means that rather than 16, there are 8 pictures in a GOP but they are evenly spaced so that the quality lost is least likely to be noticed in the replay of the video data stream. This is an advantage of having a temporal hierarchy of pictures.

When a current picture is being encoded, it is compared with already-encoded pictures, preferably of the same GOP, in the order mentioned above. These already-encoded pictures are referred to as reference pictures.

The motion estimation 318 of blocks within each current picture will now be described with reference to the pictures of the GOP illustrated in FIG. 5.

All of the pictures, whether I, P or B, are divided into blocks, which are made of a number of pixels; typically 16 by 16 pixels.

Coding of the pictures is performed on a per-block basis, such that a number of blocks are encoded to build up a full picture.

A “current block” is a block that is presently being encoded in a “current picture” of the GOP. It is thus being compared with the reference pixel area or block (of block size but not necessarily aligned with the blocks in the picture) that make up a reference picture.

During the coding process, in order to maximise the compression of the video sequence, it is desirable to find the reference block that best matches the current block. By “matches”, what is meant is that the intensity or values of the pixels that make up the reference block are close enough to those of the current block that Inter-coding has a lower cost that Intra-coding. A distance such as a pixel to pixel SAD (sum of absolute differences) is used to evaluate the “match”. This distance is also effectively a distance between two blocks, which is closely related to the likelihood of a sufficient “match”. If the distance between a current block and a reference block is small, the difference or residual may be encoded on a low number of bits.

The information regarding how much the portion of the image represented by the current block has moved with respect to the reference block takes the form of a “motion vector,” which will be described below.

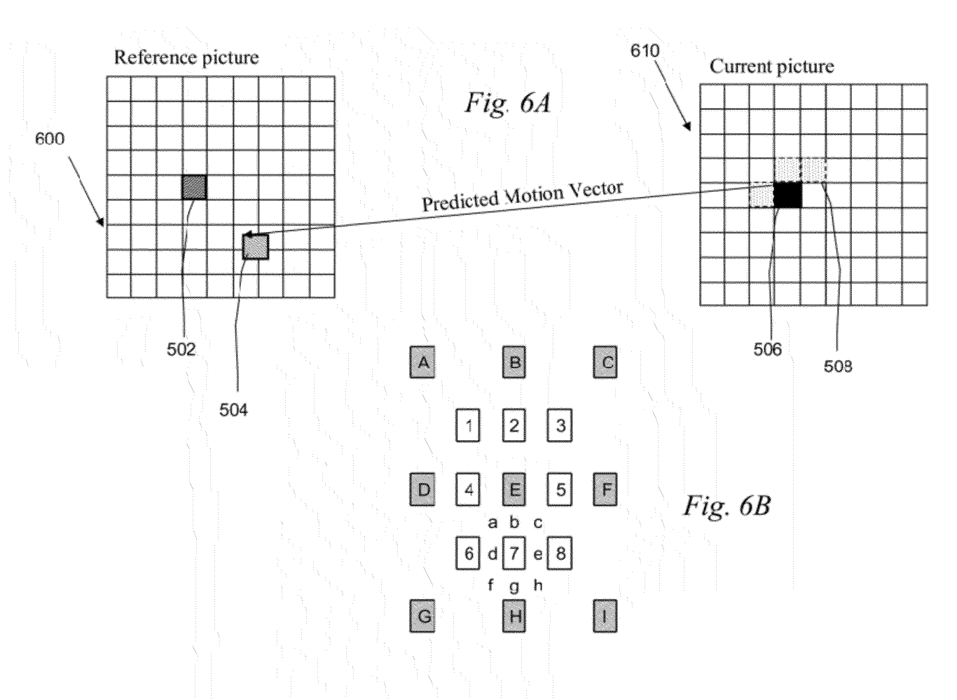

FIGS. 6A and 6B illustrate a motion estimation process used in a fast H.264/SVC encoder. As shown in FIG. 6A, the motion estimation process 318 uses two starting points 502, 504 in the reference picture 600 for the motion search. What is meant by “motion search” is the search in the reference picture(s) for a predictor for the current block that shows how much motion the image portion has undergone between the reference picture and the current picture.

The first starting point of the motion search corresponds to the co-located reference block 502 of the current block 506. The second starting point corresponds to the reference block 504 that is pointed to by a “predicted” motion vector.

A “co-located” block is a block in the reference picture that is in the same spatial position as the current block is in the current picture. If there were no motion between the reference picture and the current picture (i.e. the video sequence showed a static image), the co-located block would be the best matching reference block for the current block.

A “predicted” block 504 (in FIG. 6A) is a block in the reference picture that is at one end of the motion vector calculated as the median value of the motion vectors of (usually three) already-encoded neighboring blocks 508 of the current block. This “predicted” block may also be referred to as the “reference block pointed to by the predicted motion vector of current block”. This predicted motion vector is used to predict the motion vector of the current block. The encoding method is particularly efficient when the motion is homogeneous over a frame.

The neighboring blocks 508 that are used for the predictive coding are preferably chosen in a pattern that substantially surrounds the current block, but that are likely to have been coded already. In the example shown in FIG. 6A, the blocks have been coded from top left to bottom right, so blocks in the row above the current block 506 and in the same row but to the left of the current block 506 are likely to have already had their motion vectors calculated.

In this embodiment, a motion search (of both the first and second operations or processes) is systematically performed around the two starting points. In order to improve the efficiency of the motion search, a subset of blocks is selected to undergo a second, extended motion estimation process (using an extended motion estimation operation or process, or a “first” operation or process). If all blocks were to undergo a small-area search, large motion vectors would not be found. However, having a large search area means a slower and more complex search process for disproportionately small return, especially if the motion is not so large.

Thus, the motion search area may be extended (i.e., made larger) only for certain selected pictures where the temporal distance to the reference picture is greater or equal to a threshold value, such as 4 (i.e., for B₂ pictures in FIG. 5). Alternatively, only the P-pictures might have their search area extended, as these are the pictures that are furthest from their reference pictures and most likely to have undergone larger relative motion. For other pictures, the initial motion estimation may be the motion search shown in FIG. 6B (and as will be described below as a “second” operation or process), or may be some other more limited search area. There are several ways to select the selected pictures for which the search area will be extended, depending on the type of video data and the likelihood of large movements between pictures of the video sequence.

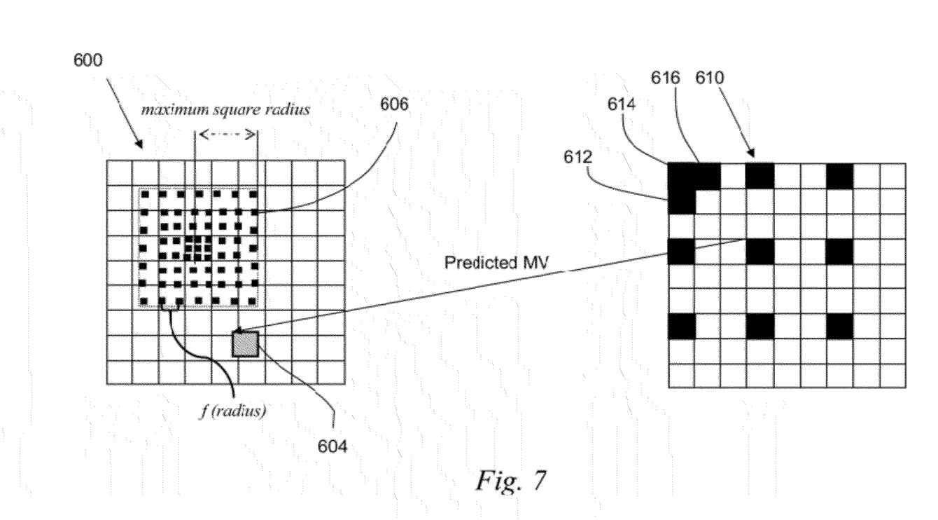

In pictures where the motion search area is extended, the extension is preferably applied for only a subset of the blocks in the picture. This first operation or process is illustrated in FIG. 7. In FIG. 7, the picture on the right 610 represents the current picture to predict and the picture on the left 600 represents the reference picture. Shaded blocks 612, 614, 616, etc. represent the blocks for which the motion search is being extended. For other blocks, a basic motion estimation process (the second operation or process) described below is employed. As an extended search area increases the complexity of the motion estimation process, this combined method, where the motion search is extended for a subset of blocks, allows a reasonable trade-off between motion estimation accuracy and limited complexity increase.

According to one embodiment, the proposed extended motion search is systematically employed in the top-left three blocks 612, 614, 616 of the picture such that the motion vectors of these block may be used afterwards to derive the predicted motion vectors for all subsequent blocks in the picture by finding their median motion vector for the subsequent block, and so on.

Further embodiments of how the selected blocks are designated for an extended motion search operation or process will be discussed further later with respect to other parameters for determining the extended motion search operation or process.

A basic, four-phase search method will be described next, followed by a description of the extended search method.

A basic, four-phase motion search is illustrated in FIG. 6B. This motion search may be performed around the two starting points 502 and 504. Letters ‘A’ to ‘I’ represent integer-pixel positions, numbers ‘1’ to ‘8’ represent half-pixel positions and letters ‘a’ to ‘h’ correspond to quarter-pixel positions. Suppose that E is the starting point. The basic motion search involves reading first ‘A’ to ‘I’ integer-pixel positions as candidate integer-pixel motion vectors. Then the best motion vector issued from these nine evaluations, i.e., which provides the lowest SAD (Sum of Absolute Differences between original and predicted blocks) undergoes a further half-pixel motion refinement operation as a second phase. This includes determining the best motion vectors amongst the best integer position and the ‘1’ to ‘8’ half-pixel positions around it. In the case shown in FIG. 6B, the best integer position is “E”. A third phase or operation in the form of a quarter-pixel motion refinement is applied around the “best” half-pixel position. In the illustrated case, the best half-pixel position is “7”. The process involves selecting, amongst the best half-pixel position and the quarter-pixel positions around it (labelled ‘a’ to ‘h’ in FIG. 6B), the motion vector leading to the minimum SAD. Finally, in a fourth phase, the motion search that leads to the best motion vector between the two initial starting points is selected to predict temporally the current block.

This basic motion search is quite restricted in search area, which ensures a good encoding speed. However, in cases where the distance between a reference picture and a current picture is large—for example, in a 16-picture GOP where the I₀/P₀ picture is 16 pictures away from its reference I₀/P₀ picture of the previous GOP—the basic motion search is much less likely to find the appropriate best matching reference block/pixels within the first, smaller search area, especially in more dynamic video sequences.

An embodiment of the invention therefore performs a modified (extended) version of the basic four phase motion search for selected current blocks. This motion estimation method finds high amplitude motion vectors (i.e., those representing large movements) when relevant, while keeping a low complexity of the motion estimation process. The problem to be solved by the embodiment is to find a good balance between complexity and motion estimation accuracy, which is required for good compression efficiency.

As in the basic search, pixels and sub-pixel areas of the same size as the current block may be read, as shown in FIG. 7.

The extended motion estimation method according to a first embodiment includes selecting a (“first”) motion search area as a function of the temporal level of the picture to encode. This extended motion estimation method takes the form of an increase of the motion search area for some selected blocks, e.g., those of low temporal level pictures (i.e., for those pictures that are further apart in the temporal dimension). This motion search extension is determined as a function of the total GOP size and the temporal level of the current picture to encode. Hence, it increases according to the temporal distance between the current picture to predict and its reference picture(s).

The left side of FIG. 7 illustrates an example of the motion search performed in its extended form according to an embodiment. As can be seen, the motion search may be extended for one starting point of the multi-phase motion estimation, i.e., the starting point corresponding to the co-located block of the block to predict. Alternatively, the starting point of the search may be the reference block 604 pointed to by the predicted motion vector; in other words, the starting point of the search may be the predicted reference block. Yet alternatively, the motion search may be extended for both starting points. Preferably, even if only one starting point starts an extended search, the other starting point(s) may also be used for a basic, non-extended motion search.

Preferably, the process of designating a search area is performed separately for each current block within the subset of current blocks, the subset of current blocks being those that are selected for an extended motion search process.

However, according to one embodiment, the extended motion search is applied around the starting point corresponding to the co-located block and this is illustrated in FIG. 7 on the left hand side. The extended motion search includes an iteration of “radial searches” around the starting point, where each radial search includes evaluating the SAD of positions (i.e., reading pixels or sub-pixel areas and obtaining intensity and/or colour values) along the perimeter of a square, the radius of the square increasing progressively. To limit the complexity of the search, the distance between successively tested positions along the perimeter of the square may increase as a function of the square radius. This is represented by the step between two positions (i.e., small black squares 606) in FIG. 7. In other words, as the square radius increases, so does the distance between the positions 606 that are read. This is one of the several ways in which the pixels that are read are inhomogeneously positioned in the search area.

The radial search of the extended motion search does not have to follow a square path, but may follow a perimeter of any concentric shape. For example, the perimeter of a circle, hexagon, or a rectangle may be followed, with the radius of the circle or hexagon increasing with every pass, or the shorter and longer sides of the rectangle increasing with every pass.

Alternatively, the search may follow a pattern that is not following concentric perimeters, but that follows some other pattern such as radiating outward along a radius from a centre point to a defined limit, then back to the starting point and radiating outward along a radius at a different angle. The skilled person may imagine alternative search shapes that would be suitable.

The radial search according to one embodiment (increasing concentric perimeters) may increase in perimeter length until a predetermined maximum search perimeter (e.g., maximum searched area) is reached.

The maximum search area may be determined in different ways according to various embodiments. One embodiment includes determining the maximum search area as a function of the likelihood of a large spatial movement between the current block and the likely best-matched reference block.

The way this may be determined may be by increasing the search area proportionally to the distance between the current picture and its reference picture(s). If the current picture is at one end of a GOP and its reference picture is at the other end of the GOP, the search area in the reference picture of the present embodiment will be larger than a search area in the case where the current picture is next to its reference picture in the GOP.

Alternatively or additionally, the search area may be increased if the temporal level of the current picture is below a certain threshold as mentioned above and/or the relative size of the search area in the reference picture may be dependent on the temporal level of the current picture. According to this embodiment, if the current picture has a temporal level of 1 (as defined above with reference to picture B₁ in FIG. 5), its reference picture is more likely to be further away than a picture with a temporal level of 4 and so the search area in this embodiment is larger than a current picture with a temporal level of 2, 3 or 4.

In a third embodiment, the size of the search area may be based on a size or magnitude of a search area previously used for finding a best-match for a previous P-block.

The size of the search area (in the reference picture) may not necessarily be the same for all blocks in a current picture. Parameters other than temporal distance between the reference picture and the current picture are also taken into account. For example, if it is found that other blocks in the same picture have not undergone significant spatial movement, the search area of the current block will not need to be as large as if it is found that other blocks in the same picture or previous pictures have undergone significant spatial movement. In other words, the size of the search area may be based on an amplitude of motion in previous pictures or previous blocks.

The extended motion estimation method may be adjusted according to several permutations of the three main parameters that follow:

The number of blocks in the current picture for which the motion search may be extended.

In the embodiment illustrated by FIG. 7, the motion search is extended for the three top-left blocks 612, 614, 616 and then for one block (shaded) out of nine.

In an embodiment, the extended motion search is applied to a subset of blocks which is designated according to the temporal level of the current picture. For example, for the lowest temporal level, the search area may be extended for every nine blocks; for the second temporal level, the search area may be extended for every 36 blocks. For the current picture with a temporal level above a given threshold, no extended motion search is performed.

In another embodiment, the extended motion search is applied to a subset of blocks which is designated according to the temporal distance between the current and the reference picture. If the temporal distance is lower than a given threshold (e.g., 8), no extended motion search is performed. For a higher temporal distance, the search area may be extended for every nine blocks.

Returning to the illustrated embodiment, the top-left block 614 is presumed to be the block that may be encoded first. The advantage of extending the search area at (e.g., predetermined) intervals throughout the current picture is as follows. More accurate motion estimation for concerned current blocks may be provided when a larger search area is available. The greater accuracy of motion vectors found through this more accurate motion estimation may thus propagate as greater accuracy for other blocks through spatial prediction of motion vectors. This is because the magnitude of motion vectors found during these extended motion searches should give an indication of what sort of extended motion estimation method to use for subsequent blocks in the same picture.

An “extension parameter” may be defined as the maximum size of the multiple concentric squares (or perimeters) in which a radial search is performed. This extension parameter is illustrated in FIG. 7 as the “maximum square radius” and is the outermost concentric square of search points 606 in the reference picture 600.

For example, the maximum size of the search area may be fixed to 80 pixels for a temporal distance equal to 16 between predicted and reference pictures, and 40 for a temporal distance equal to 8. For other pictures, the basic four-phase motion estimation may be applied. In other words, for selected blocks in the current picture shown as shaded in the current picture 610 of FIG. 7, the extended motion estimation operation or process may be applied and in the rest of the blocks, the basic four-phase motion estimation operation or process illustrated in FIG. 6B may be applied.

The “step” distance between two successive evaluated positions 606 may be calculated as an affine function of the radius (f(radius)) of the current search square that contains the evaluated positions, the function being according to equation (1):

$$Step = \frac{( Radius - 2 ) \times ( MaxStep - 3 )}{ExtensionParameter - 2} + 3 \qquad ( 1 )$$

where MaxStep represents the maximum Step value between two successive positions in the largest square of the search area (“maximum square radius”) and Radius is the square radius of the presently-searched square. The result is thus that the step increases as the current radius increases so that evaluation positions 606 are further apart, the larger the radius, as illustrated in FIG. 7.

These three motion search extension parameters can be adjusted to reach an acceptable trade-off between calculation time increase (as compared to the intial four-phase motion search process) and precision of the determined motion vectors. Increasing the search area increases the calculation time, but improves the accuracy of motion estimation. Selectively increasing the search area for certain current blocks therefore enables the acceptable trade-off.

Further factors may be used to determine the maximum search area for each current block. The magnitude of the search area used for finding the best reference block for blocks in a previous P-picture may be used for subsequent B-pictures. A maximum may be applied that is dependent on the relative position of the current block or the size of the picture; or on a pattern of motion vectors for other pictures within the same GOP.

An example follows of determining the maximum search area (i.e., determining the extension parameter of the search area) in case of B pictures inside an SVC GOP. It is possible to determine the extension parameter as a function of the magnitude of motion vectors that have already been determined in the reference pictures of current B picture. To do this, one has first to obtain the average (this could also be the maximum) of motion vectors determined in an area around the current macroblock in the current picture's reference pictures. This may successively consider the two reference pictures of the current B picture, and calculate the average motion vector amplitude respectively in these two reference pictures. The average motion vector is found for a set of blocks that spatially surrounds the current block for which prediction is being performed. Once the average motion vector amplitude has been obtained for each reference picture, an extension parameter for the motion search around the current block is determined, for both forward and backward motion estimation. This extension parameter is obtained by scaling (i.e., reducing) the considered average motion vector amplitude by a scaling factor that depends on the temporal distance between the predicted picture and the considered reference picture.

The search area is preferably different for different blocks within a same picture (and within different pictures) and each search area may be independently (or at least separately) designated depending on parameters discussed above.

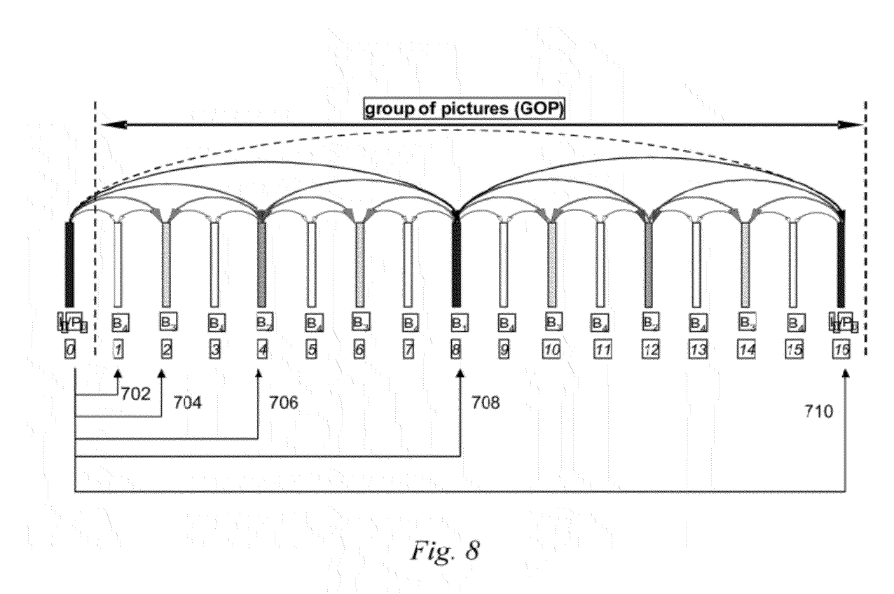

An alternative embodiment is illustrated in FIG. 8. In this embodiment, as the pictures are loaded, motion estimation is performed on some of the pictures at this time, rather than waiting until all pictures are loaded before encoding them.

In other words, the motion estimation technique may include the following phases: during an operation of loading a plurality of pictures in a group of pictures in temporal order, reviewing a number of the pictures to determine motion vectors between the number of pictures and a common reference picture; from the motion vectors, estimating an amount of movement that occurs in a spatial direction of the pictures in the group of pictures; and optimizing the search areas for reference blocks in reference pictures for subsequent current pictures based on the estimated amount of movement in the group of pictures.

For example, forward motion estimation 702 is performed on the first picture 1 (B₄) as it is loaded based on the I₀/P₀ picture 0 of the previous GOP. With respect to the illustration of FIG. 8, this assumes the key picture (picture with index 0) preceding the current GOP is available in its reconstructed version. This motion estimation process may re-use the initial basic four-phase motion search of FIG. 6B as is.

Then, as the second picture 2 (B₃) of the GOP is loaded, forward motion estimation 704 is performed on it based on the I₀/P₀ picture 0 of the previous GOP. In this motion estimation, the motion search area that is centred on the co-located reference blocks of successively processed blocks is extended as a function of the motion vectors that were found in previous picture numbered 1. Typically, for each processed block in picture 2, an average or median is calculated of motion vector amplitudes in picture 1, the average being over a spatial area that surrounds the current block's position, such as the four blocks 508 surrounding the current block 506 shown in FIG. 6A. Then this average motion vector amplitude is increased according to a scaling ratio. This scaling ratio can be calculated as the division between the temporal distance between pictures 0 and 2 on one side, and the temporal distance between picture 0 and 1 on the other side.

Then, as the fourth picture 4 (B₂) of the GOP is loaded, forward motion estimation 706 is performed on it based on the I₀/P₀ picture 0 of the previous GOP. As the eighth picture 8 (B₁) of the GOP is loaded, forward motion estimation 708 is performed on it based on the I₀/P₀ picture 0 of the previous GOP, and finally, as the sixteenth picture 16 (I₀/P₀) of the GOP is loaded, motion estimation 710 is performed on it based on the same I₀/P₀ picture 0 of the previous GOP. The forward motion estimation on pictures as described above does not bring any complexity increase because the resulting motion vectors can be used during the effective picture coding afterwards.

These ready-determined motion vectors may then form the basis for accurate determination of motion vectors for the rest of the pictures. These may also be used to designate selected blocks to undergo an extended motion search in other pictures. For example, the search areas for the rest of the selected blocks may be optimized based on the estimate of the amount of movement. Small movements can give rise to smaller search areas and large movements to large search areas or more displaced starting points for the searches.

This way, this forward motion estimation operation (702 to 710) not only provides useful information on the amplitude of the motion contained in the loaded picture, but it also provides a motion field (of motion vectors) that may be re-used during the effective encoding of the current picture.

This embodiment provides a good trade-off between speed and motion estimation accuracy. Indeed, the motion search area is only being extended when the result of the previous forward motion estimation indicates that motion with significant amplitude is contained in the considered video sequence.

A common point between this embodiment and the preceding ones is that the motion search area in one picture is adjusted as a function of the temporal level of this picture and also as a function of the motion already determined in an already-processed picture. Thus, the embodiment depicted in FIG. 8 is useful in designating which blocks of which current pictures will have the first extended motion prediction operation or process applied to them and which will have the second basic prediction operation or process applied to them. The designation is based, in this case, on the relative motion between portions of pictures found during the motion prediction of pictures 1, 2, 4, 8 and 16 at the time of their uploading.

Another common point is that a number of blocks are selected for the extended search method, not necessarily all of them. The number of blocks selected may be designated in the same ways as described above.

Pictures in an entire GOP are thus encoded and output as a coded, compressed bitstream. Specifically, an embodiment includes a technique for encoding a video sequence comprising at least one group of pictures, the technique including the technique as described above to determine the motion search extension for some pictures in the GOP and for a subset of blocks in these pictures as a function of the amplitude of motion vectors already determined in pictures previously treated by the video encoding process. Further embodiments may include the designating of selected current blocks for undergoing an extended motion estimation process via a “first operation or process”. Furthermore, one embodiment includes a video encoding apparatus for encoding the video sequence as shown in FIG. 1, for example. This video encoding apparatus includes at least: means for selecting a current picture in the group of pictures; means for designating the subset of current blocks in the current picture; means for selecting a reference picture in which to search for a reference block that matches each current block in the current picture; means for applying the first operation or process to the current blocks within the subset of current blocks to search for reference blocks in a first search area in the reference picture that best match said current blocks within the subset; and means for applying the second operation or process to the current blocks not within the subset of current blocks to search for reference blocks in a second search area in the reference picture that best match said current blocks not within the subset.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., video encoder). In addition, the operations in the method transform the elements or parts from one state to another state. The transformation is particularized and focused on video encoding. The transformation provides a different function or use such as searching for reference blocks, etc.

The skilled person may be able to think of other applications, modifications and improvements that may be applicable to the above-described embodiment. The present invention is not limited to the embodiments described above, but extends to all modifications falling within the scope of the appended claims.

This application claims the benefit of Great Britain Patent Application No. 1014667.8 filed Sep. 3, 2010, which is hereby incorporated by reference herein in its entirety.

What is claimed is:

1. A method of searching a reference picture comprising a plurality of reference blocks for reference blocks that best match current blocks in a current picture in a video encoder, the method comprising:
designating a subset of current blocks in the current picture;
applying a first operation to the current blocks within the subset of current blocks to search for reference blocks in a first search area in the reference picture that best match said current blocks within the subset; and
applying a second operation to the current blocks not within the subset of current blocks to search for reference blocks in a second search area in the reference picture that best match said current blocks not within the subset.

2. The method according to claim 1, wherein at least the first operation comprises:
designating the first search area comprising at least one block within the reference picture;
reading at least one block partition of said at least one block within the search area; and
determining, from said read at least one block partition, which of said at least one block is a best match of the current block.

3. The method according to claim 2, wherein
the current and reference pictures are in a same group of pictures in which all pictures are assigned a temporal level defined by their position within the group of pictures, and
the designation of a size of the first search area for at least the first operation is performed as a function of the temporal level of the current picture.

4. The method according to claim 3, wherein the size of the first search area is increased for at least the first operation if the temporal level of the current picture is below a predetermined threshold.

5. The method according to claim 2, wherein designating the first search area comprises designating an area based on a magnitude of motion vectors calculated for a previously processed picture.

6. The method according to claim 1, wherein the second operation comprises a basic four-phase motion search.

7. The method according to claim 1, wherein the first search area of the first operation is larger than the second search area of the second operation.

8. The method according to claim 1, wherein the first and second operations use at least two starting points for the searches.

9. The method according to claim 1, wherein the first operation comprises searching the first search area from a first starting point and reading inhomogeneously positioned reference blocks within the first search area.

10. The method according to claim 9, wherein the distance between said reference blocks increases as a function of distance from the first starting point.

11. The method according to claim 1, wherein the size of the first search area in the first operation depends on an amplitude of motion in previous pictures.

12. The method according to claim 1, wherein the first operation comprises reading pixels in at least one block within the first search area and obtaining pixel values for pixels in the following order:
reading pixels within a block in the centre of the search area;
reading pixels around a perimeter surrounding the block in the center of the search area;
increasing a perimeter size and reading pixels around the next perimeter; and
iteratively increasing the size of the perimeter until a predetermined outer perimeter of the first search area is reached.

13. The method according to claim 12, wherein, as the size of the presently—searched perimeter is increased, the distance between read pixels is also increased.

14. The method according to claim 2, wherein designating the first search area comprises designating an area surrounding a co-located reference block.

15. The method according to claim 2, wherein designating the search area comprises designating an area surrounding a reference block designated by a predicted motion vector.

16. The method according to claim 1, further comprising:
during loading of a plurality of pictures in a group of pictures in temporal order, reviewing a number of the pictures to determine motion vectors between the number of pictures and a common reference picture;
from the motion vectors, estimating an amount of movement that occurs in a spatial direction of the pictures in the group of pictures; and
optimizing the search areas for reference blocks in reference pictures for subsequent current pictures based on the estimated amount of movement in the group of pictures.

17. The method according to claim 2, wherein designating a first search area is performed separately for each current block within the subset of current blocks.

18. The method according to claim 1, wherein designating the subset of current blocks comprises designating blocks separated by a predetermined interval within the current picture.

19. The method according to claim 1, wherein designating the subset of current blocks comprises designating at least one block from the current picture that is encoded first among a predetermined group of blocks of said picture.

20. The method according to claim 1, wherein
the current picture and the reference picture are in a same group of pictures in which all pictures are assigned a temporal level defined by their position within the group of pictures, and
the designation of the subset of current blocks in the current picture is performed as a function of the temporal level of the current picture.

21. The method according to claim 1, wherein designating the subset of current blocks comprises taking into account a temporal distance between the current picture and the reference picture.

22. A method of encoding a video sequence in a video encoder including a method of searching a reference picture comprising a plurality of reference blocks for reference blocks that best match current blocks in a current picture, the method comprising:
designating a subset of current blocks in the current picture;
applying a first operation to the current blocks within the subset of current blocks to search for reference blocks in a first search area in the reference picture that best match said current blocks within the subset; and
applying a second operation to the current blocks not within the subset of current blocks to search for reference blocks in a second search area in the reference picture that best match said current blocks not within the subset.

23. A method of encoding a video sequence in a video encoder comprising at least one group of pictures, the pictures each comprising a plurality of blocks, the method comprising, for each current block within each current picture in the video sequence,
obtaining a first rate distortion cost associated with a first encoding mode using the reference block found for said current block by searching a reference picture comprising a plurality of reference blocks for reference blocks that best match current blocks in a current picture, searching comprising:
designating a subset of current blocks in the current picture;
applying a first operation to the current blocks within the subset of current blocks to search for reference blocks in a first search area in the reference picture that best match said current blocks within the subset; and
applying a second operation to the current blocks not within the subset of current blocks to search for reference blocks in a second search area in the reference picture that best match said current blocks not within the subset, the method further comprising:
obtaining a second rate distortion cost associated with a second encoding mode for encoding said current block;
comparing said obtained first and second rate distortion costs; and
encoding said current block according to the encoding mode with the lowest rate distortion cost according to said comparison.

24. A video encoding apparatus for encoding a video sequence comprising at least one group of pictures, the pictures each comprising a plurality of blocks, the video encoding apparatus comprising:
a first selecting unit configured to select a current picture in the group of pictures;
a designating unit configured to designate a subset of current blocks in the current picture;
a second selecting unit configured to select a reference picture in which to search for a reference block that best matches each current block in the current picture;
a first applying unit configured to apply a first operation to the current blocks within the subset of current blocks to search for reference blocks in a first search area in the reference picture that best match said current blocks within the subset; and
a second applying unit configured to apply a second operation to the current blocks not within the subset of current blocks to search for reference blocks in a second search area in the reference picture that best match said current blocks not within the subset.
